(19) United States
(12) Patent Application Publication
(10) Pub. No.: US 2025/0114972 A1
(43) Pub. Date: Apr. 10, 2025

(54) FORM PRESSURE CONCRETE MONITOR

(71) Applicant: SmartPour, LLC, Vancouver, WA (US)

(72) Inventors: Ashley McWatters, Vancouver, WA (US); Cory Church, Vancouver, WA (US); Greg Lucier, Raleigh, NC (US); Harley Meiers, Seattle, WA (US)

(73) Assignee: SmartPour, LLC, Vancouver, WA (US)

(21) Appl. No.: 18/910,999

(22) Filed: Oct. 9, 2024

Related U.S. Application Data
(60) Provisional application No. 63/589,012, filed on Oct. 9, 2023.

(51) Int. Cl. B28B 17/00; G01L 9/04; G01L 19/00; G01L 19/14

(52) U.S. Cl. CPC B28B 17/0081; G01L 9/04; G01L 19/0092; G01L 19/14

(57) ABSTRACT

Form pressure concrete monitor systems and processes are disclosed. Various embodiments of the present invention enhance the form pressure monitoring of concrete by using a load cell, a custom-designed load cell assembly, a data processing and transmission module, and a user-friendly interface for real-time monitoring, data analysis and retention, record keeping, and decision-making.

### CROSS REFERENCE TO RELATED APPLICATIONS

This application claims the benefit of U.S. Provisional Patent Application No. 63/589,012, which was filed on Oct. 9, 2023, and entitled “FORM PRESSURE CONCRETE MONITOR.” The complete disclosure of the above application is hereby incorporated by reference for all purposes.

### FIELD OF THE DISCLOSURE

The present disclosure pertains to a form pressure concrete monitor system designed to address safety concerns and challenges associated with concrete pouring during construction projects, featuring a custom-designed load cell assembly, data processing and transmission module, and a user-friendly interface for real-time monitoring, data analysis, and decision-making.

### BACKGROUND

None.

### BRIEF DESCRIPTION OF THE DRAWINGS

For a better understanding of the present disclosure, and to show how the same may be carried into effect, reference will now be made, by way of example, to the accompanying drawings, in which:

FIG. 1A is a perspective view of an embodiment of a custom-designed load cell's upper housing;

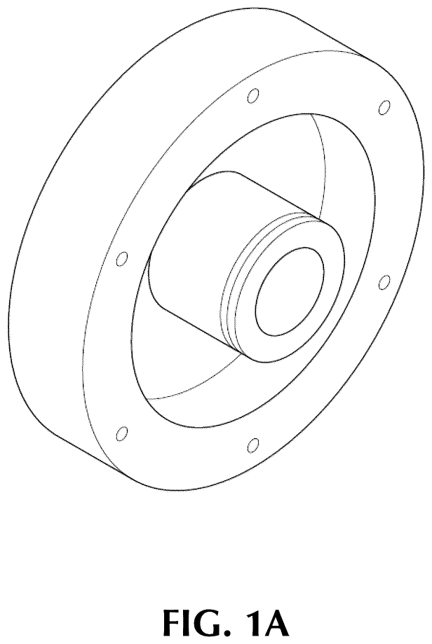

FIG. 1B is a perspective view of an embodiment of a custom-designed load cell's lower housing;

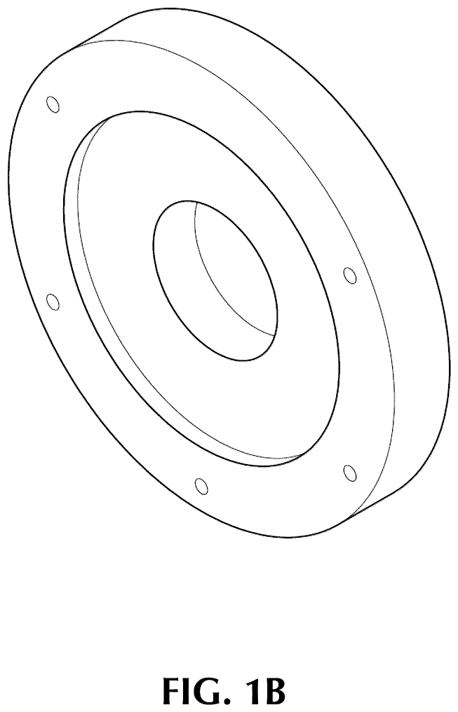

FIG. 2 is a schematic diagram of various components of an illustrative data processing system; and

FIG. 3 is a schematic representation of an illustrative distributed data processing system.

### DETAILED DESCRIPTION

The need for a form pressure concrete sensor arises from the critical importance of ensuring the safety, precision, and efficiency of concrete pouring processes in construction projects. Traditional methods of monitoring form pressure have proven inadequate, leading to various challenges and potential risks. Without an advanced form pressure concrete sensor, construction professionals lack a reliable means of accurately gauging and controlling the immense forces exerted by concrete during placement.

One of the primary issues revolves around the potential danger posed to workers due to flying bolts and other hazards resulting from formwork blowouts during the pouring process. Without a reliable means of monitoring and controlling form pressure, the safety of on-site personnel may be compromised, and the construction site becomes susceptible to accidents and injuries. Furthermore, the significant financial implications of costly and time-consuming formwork blowouts highlight the critical role of a form pressure concrete sensor. These blowouts not only result in substantial project delays but also lead to budget overruns and resource wastage.

These numerous challenges and safety concerns persist today. Conventional methods and tools for monitoring concrete form pressure have exhibited notable shortcomings, prompting the need for innovative and calibrated alternatives.

Traditional approaches to form pressure monitoring typically lack calibration, which hinders their precision and accuracy. In contrast, the form pressure concrete monitor system presented in the present disclosure is calibrated, ensuring that measurements of compressive forces are highly accurate, allowing for precise control during concrete placement.

Moreover, conventional solutions are often single use, rendering them impractical and costly for repeated utilization across various construction projects. The innovation introduced herein breaks away from this restrictive pattern, offering a reusable and adaptable form pressure concrete monitor system capable of serving a multitude of applications.

The existing tools and equipment employed for form pressure monitoring are frequently ill-suited for the specific demands of concrete pouring. For instance, some solutions resort to single-use hydro cylinders that are not tailored to the intricacies of form pressure. In contrast, the form pressure concrete monitor system leverages a custom-designed load cell assembly, engineered to accurately measure forces, weight, and pressure from a form tie expansion, thereby optimizing safety and efficiency during concrete placement.

Furthermore, traditional monitoring systems are often directly tied to the form or formwork itself, limiting their flexibility and ease of deployment. In contrast, the form pressure concrete monitor system innovatively attaches to the form tie, streamlining the installation process and facilitating the real-time monitoring of concrete pressures during construction projects. This departure from conventional practices marks a significant advancement in form pressure monitoring, offering enhanced versatility and effectiveness while contributing to improved construction site safety.

Disclosed herein is a novel form pressure concrete monitor, which addresses the complex challenges and safety concerns inherent in concrete pouring during construction projects. The present disclosure details the form pressure concrete monitor, its structural intricacies, operational processes, software component, and potential applications.

At the core of the form pressure concrete monitor lies a custom designed load cell assembly. This design strikes a balance between lightweight construction and robust resilience. Its primary structure embodies a cylindrical core. Its exceptional versatility enables effortless adaptation to square, rectangular, or even diamond-shaped profiles. This adaptability ensures compatibility with an array of form tie shapes, catering to the diverse needs of construction projects.

The load cell includes a transducer or sensor designed to convert a mechanical force or load into an electrical signal. In the context of the present disclosure, it is used to measure force, weight, and pressure from a form tie expansion accurately. The load cells may be designed in various shapes and sizes, but for illustration of the disclosure, a cylindrical load cell will be described and discussed.

The load cell is a specialized device designed for accurately measuring compressive forces or loads. It operates on the principle of deformation caused by applied pressure. These load cells are primarily employed in applications where loads are pushed or compressed along a central axis.

The load cell, disclosed herein, features a cylindrical or columnar shape, allowing it to effectively handle and measure forces in a compressive direction. Notably, the load cell incorporates a central opening traversing its entirety, thereby forming a distinctive donut shape.

This structural design featuring the donut-shaped opening serves to enhance the load cell's capabilities in measuring and responding to compressive forces. The incorporation of the central void allows for efficient load distribution and optimal force transfer through the load cell. Moreover, the donut-shaped aperture introduces a geometric attribute that can be leveraged for specific applications and mounting arrangements, further enhancing the versatility and utility of the load cell.

The utilization of this load cell with a donut-shaped opening brings advancements in various fields where precise measurement of compressive forces is essential. Its unique design characteristics enable improved accuracy and reliability in force measurement applications, thus contributing to enhanced safety, quality control, and operational efficiency in relevant industries.

The core component of the load cell's functionality resides in its sophisticated sensing element, which is designed to respond to compressive forces with precision and accuracy. In some embodiments, this sensing element encompasses a set of highly sensitive components, including strain gauges or piezoelectric crystals. These elements are strategically integrated into the load cell's structure to ensure optimal performance.

Upon the application of pressure, the sensing element undergoes controlled deformation, resulting in discernible alterations in critical electrical parameters, such as resistance or voltage. These modifications serve as indicators of the magnitude and distribution of the compressive force being measured.

In some embodiments, to further enhance the load cell's capabilities in accurately gauging compressive forces and ensuring reliable data acquisition, a strategically positioned array of four sensors is employed. Two of these sensors are situated in close proximity to the donut-shaped opening, positioned at 180-degree intervals from one another, and designed to measure compression. The remaining two sensors are located at the outer end of the load cell, also separated by 180 degrees, albeit rotated by 90 degrees relative to the sensors proximate to the donut-shaped opening, and designed to measure tension.

This arrangement of sensors serves a distinct purpose: it enables the load cell to capture and analyze the differential pressure between the two sets of sensors. By measuring variations in voltage output from each set, the load cell is adept at converting these differences into precise load measurements, in some embodiments, expressed in pounds (lbs.) or any other suitable unit of measurement. This configuration contributes to the load cell's capacity to provide accurate and real-time data on compressive forces, making it a valuable tool in numerous applications where precise force monitoring is imperative.

The mounting of the load cell is an integral step in ensuring accurate and real-time measurement of compressive forces in multiple applications, but specifically during concrete placement. The load cell, featuring its distinctive cylindrical or columnar shape with a central donut-shaped opening, is designed for practical and efficient installation in construction settings.

To initiate the mounting process, a user, such as a contractor or superintendent, follows a streamlined and user-friendly procedure. The load cell is positioned on a form tie that has been securely installed on the formwork. This placement involves sliding the load cell over the form tie, leveraging the central donut-shaped opening as a fitting enclosure. A metal washer is then positioned over the load cell's central opening and securely fastened. This process ensures that the load cell is tightly secured and aligned with the compressive forces exerted during the concrete pour. It is important to note that the load cell is not the form or formwork itself, but rather it is mounted onto the form tie.

The donut-shaped load cell with its strategically positioned array of four sensors opens the door to a myriad of versatile applications across various industries. One prominent application lies within the realm of construction and civil engineering. In this domain, the load cell can be employed to monitor the pressure exerted by concrete during placement, as showcased in herein. By analyzing the differential pressure between the inner and outer sensors, contractors and engineers gain critical insights into the structural integrity of concrete formwork, thereby mitigating the risk of costly blowouts and delays while enhancing construction site safety.

In some embodiments, the load cell utilizes strain gauges, which are electrical resistance devices, that are attached to a load-receiving element (discussed below). The strain gauges are arranged in a Wheatstone bridge configuration, consisting of four strain gauges. When force is applied to the load cell, the strain gauges undergo deformation along with the load-receiving element, causing changes in electrical resistance. This change in resistance is proportional to the applied force and is the basis for measuring the load.

The load cell also includes a load-receiving element which represents a component within the donut-shaped load cell's structural framework. It serves as the primary point of contact for bearing the applied force or load. In the context of this unique load cell design, the load-receiving element is best understood while considering the housing of the load cell, which is composed of two distinct components: the upper housing and the lower housing.

The upper housing, which encompasses the outer periphery of the load cell, maintains a flat and uniform surface, facilitating consistent distribution of compressive forces. However, a notable feature of the upper housing is its elevation or lip around the donut-shaped opening. This raised portion, constituting the load-receiving element, plays a role in directly interfacing with the compressive force. It is designed to efficiently transmit and concentrate the force onto the two inner sensors, thereby enabling precise measurement and analysis of pressure differentials.

The lower housing, forming the lower portion of the load cell, complements the load-receiving element by providing structural support and stability. Together, the upper and lower housing components interconnect together through any suitable fastening means, such as nuts and bolts, thereby forming the housing of the load cell, with the load-receiving element at its core. This housing and load-receiving element are made of a piece of metal, usually made of stainless steel or aluminum, and it is designed with a specific shape to efficiently transmit the force to strain gauges.

This configuration allows the load-receiving element to be optimally positioned to engage with compressive forces, allowing for accurate force measurement through the load cell's sensors. The load-receiving element's distinct raised portion, particularly in proximity to the donut-shaped opening, serves to capture and facilitate the differential pressure readings that are essential for precise force monitoring and data analysis in a wide range of applications.

The housing of the donut-shaped load cell also plays a role in safeguarding the intricate internal components from adverse environmental conditions, acting as a protective enclosure to form a robust shield, effectively shielding the load cell from external factors such as moisture, dust, and contaminants that might otherwise compromise its performance. Beyond environmental protection, the housing also serves as a structural element, offering mechanical support to the load cell. It ensures the load cell's stability and integrity during its operational life, even in demanding applications. By enveloping the load cell's sensitive components within this robust housing, the load cell is equipped to deliver consistent and reliable force measurement results in a variety of challenging and dynamic real-world scenarios.

In use, the donut-shaped load cell, the load-receiving element, featuring its distinct raised portion around the central opening, undergoes controlled deformation. This deformation is a direct response to the magnitude and distribution of the applied force. Notably, the load-receiving element's design is tailored to facilitate precise and concentrated force transmission, a key characteristic that contributes to the load cell's accuracy in measuring compressive loads.

Within the load cell's housing, the positioned array of four sensors, in some embodiments consisting of strain gauges or other sensitive elements, is responsible for detecting and quantifying these deformations. These sensors are arranged to measure variations in the load-receiving element's shape and dimensions, particularly in response to the differential pressure exerted during the application of the compressive force.

Similar to a Wheatstone bridge circuit, the four sensors in the donut-shaped load cell are interconnected and connected to external measurement instrumentation or signal conditioning equipment. As the load-receiving element deforms in response to the applied force, the resistance values of the sensors change, creating an imbalance within the sensor array. This imbalance results in the generation of a voltage output. It is worth noting that the output voltage produced by the donut-shaped load cell's sensors is typically of low magnitude, necessitating amplification and processing by external electronics to yield a practical and accurate measurement signal. Through this intricate process, the load cell ensures precise and reliable measurement of compressive forces in a variety of applications.

Although the present disclosure primarily focuses on the applications in concrete forms, it's important to recognize that load cells, including the innovative donut-shaped load cell described herein, have an extensive range of applications across diverse industries. These versatile sensors find utility in industrial weighing, where they accurately measure the weight of objects, as well as in material testing for assessing the mechanical properties of various materials, to name a few. This broad spectrum of applications highlights the adaptability of the donut-shaped load cell.

In an embodiment of the donut-shaped load cell, the load cell is designed and calibrated to accommodate a load or pressure capacity of 40,000 pounds, making it well-suited for applications demanding the measurement of substantial forces. The calibration process involves subjecting the load cell to a series of carefully controlled force applications, incrementing in 10,000-pound intervals throughout the specified range. During each calibration step, the load cell's sensors capture and record the corresponding output data. These data points are then used to create a calibration curve or table, allowing for accurate linearization of the load cell's responses to varying loads. This calibration procedure guarantees that the load cell's measurements remain highly accurate, even when subjected to loads ranging from the smallest to the maximum capacity. It should be noted that the load cell may accommodate different load levels and calibrated using different intervals.

Another component of the form pressure concrete monitor is a data processing and transmission module or dongle. This component is connected to the load cell, serving as a conduit for storing, processing, and transmitting critical data. The data processing and transmission module may be external to the load cell and connected to it through appropriate wiring and connections. In alternative embodiments, the dongle is housed within the load cell itself.

The data processing and transmission module, or dongle, may be composed of any combination of necessary elements mentioned above. Depending on specific embodiments and use cases, the dongle can be configured to incorporate various components or modules disclosed herein. For precise timestamping of data, a real-time clock (RTC) is included in the dongle. This clock maintains accurate timekeeping and synchronization, ensuring that all recorded data is associated with the exact moment of capture.

The data processing and transmission module may include a custom-designed PCB. This circuit board serves as the central nervous system of the device, coordinating the functions of all other components. A microcontroller may also be included within the dongle to manage various functions, including interfacing with the load cell, data processing, and wireless connectivity.

Embedded within the dongle is a data processing unit. This unit includes a microcontroller, memory, and specialized processing algorithms. It is responsible for collecting raw data from the load cell's sensors, performing calculations, and converting this data into precise load measurements and pressure readings. To ensure data integrity and redundancy, the dongle features a dedicated data storage unit. This unit typically includes non-volatile memory, such as flash storage, capable of storing historical data records. These records are invaluable for post-analysis and quality control. In alternative embodiments, the data collected from the load cell, the data processing and transmission module, and any sensors discussed herein may be seamlessly stored in a secure cloud storage unit.

The dongle may include any one or more wireless communication modules such as near field communications (NFC), BLUETOOTH®, Wi-Fi, or mobile broadband networks. Wi-Fi provides a reliable local network connection, while Bluetooth facilitates short-range data exchange with nearby devices. Cellular services enable remote communication, ensuring that data can be transmitted even in remote construction sites. NFC technology can be integrated into the dongle, enabling convenient, close-range data transfers between compatible devices. In addition, one or more antennas may be integrated into the dongle's design. These antennas are optimized for each communication protocol, ensuring stable and robust wireless connections. Moreover, incorporating a global positioning system (GPS) module into the dongle enhances the form pressure concrete monitor's capabilities by providing precise location tracking during concrete placement.

The dongle is also designed with a power supply system. Depending on the specific embodiment, it may incorporate rechargeable batteries, or a connection to a power source. The dongle may also feature external ports or connectors for ease of integration with other monitoring equipment or devices on the construction site as needed. Moreover, in some embodiments, the dongle includes a user-friendly interface, such as LED displays, a light source, a sounding alarm, or status indicators.

The dongle is securely housed within a weather-resistant enclosure. This robust casing shields the internal components from adverse environmental conditions, such as moisture, dust, and physical impact. The enclosure enhances the dongle's durability, ensuring reliable performance in challenging construction site environments. Optionally, rather than an external dongle, the data processing and transmission module may reside in the housing.

The dongle also includes firmware, dictating its operation and data processing algorithms. This software, explained in more detail below, can be updated remotely to enhance functionality or address potential issues, providing flexibility and adaptability to the device. To complete the dongle's features, security measures are integrated into the dongle's design. These measures include encryption protocols and authentication mechanisms, safeguarding data during both transmission and storage.

While the load cell and the dongle work together to capture and process real-time data during concrete placement, a wireless user interface may be used as the interface through which users interact with the system. This user-friendly device allows construction professionals, superintendents, and project managers to access vital information, input commands, and receive crucial readings from the dongle, all in real time. It serves as the conduit for seamless communication between the construction site and the data processing hub, offering convenience, efficiency, and safety in the management of concrete pouring processes.

The user interface for the form pressure concrete monitor is a versatile and accessible platform designed to facilitate seamless communication between construction professionals and the monitoring system. This interface can take various forms, including a dedicated mobile app, a web-based application accessible on computers and mobile devices, or even integration with wearable technology.

Users may be authorized to input essential data to tailor the monitoring process to the specific construction project. This includes information such as the size and dimensions of the concrete form, the type of concrete being used, the ambient temperature, humidity levels, and the time of day. These inputs help customize the monitoring parameters to suit the project's unique requirements. In embodiments where the dongle includes a GPS module, environmental information may be obtained from the dongle based on its location.

The user interface serves as a dashboard that displays real-time data received from the dongle connected to the load cell. Users can monitor critical metrics such as form pressure, load distribution, and/or the progress of the concrete pour. Visual representations, graphs, and charts offer an intuitive way to grasp the ongoing process.

Leveraging historical data collected from previous projects and monitored parameters, the system can provide predictive insights. Users can receive estimates on the time required for concrete curing, the speed of the pour, and other relevant factors, helping them make informed decisions and optimize project timelines. For instance, in situations of elevated pressure levels, the system provides timely alerts, prompting users to consider a reduction in pour speed. Conversely, when pressure readings indicate a favorable margin, the system suggests or endorses an accelerated pour pace as an opportunity to expedite operations, optimizing project efficiency.

The user interface is equipped with an alert system. It can promptly notify users of any anomalies or critical events during the concrete placement, such as form pressure nearing dangerous levels or deviations from expected curing times. These notifications enable proactive responses to prevent costly mishaps.

In some embodiments, to support project documentation and analysis, the user interface allows users to export data and generate comprehensive reports. These reports can include a detailed record of concrete pour parameters, environmental conditions, and historical trends for quality assurance and regulatory compliance.

Moreover, the user interface is designed for compatibility with various devices, ensuring accessibility for both on-site personnel and remote project managers. Whether accessed on smartphones, tablets, computers, or wearable devices, it offers flexibility in monitoring and decision-making. The interface is simple and intuitive, making it accessible to construction professionals with varying levels of technical expertise. Clear navigation, informative tooltips, and contextual guidance enhance usability.

The user interface for the form pressure concrete monitor serves as the link between users and the load cell and dongle combination. It allows users to input project-specific data, receive real-time readings, access predictive insights, and take proactive measures to ensure the success and safety of concrete placement projects. Its versatility and user-centric design make it a valuable tool for construction professionals across various roles and responsibilities.

In addition to its core functionality, the form pressure concrete monitor system can be further enhanced through a modification to include any one or more of temperature, humidity, and moisture sensing capabilities. By integrating these sensors into the system, construction professionals gain the ability to monitor and analyze concrete cure rates, temperature variations, and humidity levels in real time. This addition allows for a comprehensive understanding of the curing process, enabling users to optimize construction timelines, ensure the concrete reaches its desired strength efficiently, and mitigate potential issues related to environmental variations.

Put in practice, in a construction project involving the creation of a high-rise building in an urban environment, for example, concrete pouring is a critical phase of this project, and precision and safety are paramount. The form pressure concrete monitor streamlines this process. As the construction crew prepares for the concrete pour, they seamlessly integrate the custom-designed load cell onto the form ties that structure the building's concrete molds. The load cell, with its donut-shaped opening and sensors, begins monitoring the pressure exerted by the concrete as it is poured into the molds.

Connected to a dongle, the load cell continuously transmits real-time data to a user-friendly interface accessible on the project manager's tablet, for instance. The interface displays critical information, including form pressure, load distribution, and/or curing time predictions based on historical data. As the concrete pour progresses, the system sends alerts to the project manager's device, indicating any anomalies or pressure fluctuations that could jeopardize the structural integrity of the formwork. Project managers can make informed decisions, adjusting pour speed or taking preventive actions to avoid blowouts. This real-time monitoring and data-driven decision-making ensures the safety of the construction site, prevents costly delays, and ultimately contributes to the successful completion of the high-rise building project.

The form pressure concrete monitor system offers a straightforward and user-friendly process for monitoring concrete pours, enhancing safety, and ensuring successful project outcomes. To use the system effectively, the user follows these steps: First, the user sets up the form pressure concrete monitor system by attaching the dongle to the load cell and ensuring it is powered on. In alternative embodiments, the dongle is formed as a singular unit within the load cell itself. Then, the user accesses the form pressure concrete monitor application on an external device such as a mobile phone, logs in, and gains real-time monitoring capabilities.

Next, the user secures the form pressure concrete monitor unit by sliding it onto a form tie that's securely installed on the formwork structure. To ensure a stable and reliable connection, the user places a metal washer over the load cell's center and fastens it securely with a nut. As the concrete pouring process commences, the load cell continuously sends real-time data to the dongle, which then translates and transmits this data to the form pressure concrete monitor application, providing constant updates on the concrete pressures building within the formwork.

Should the system detect a risk of formwork overload due to excessive concrete pouring, it triggers an immediate alert through the application or any other suitable means, such as sounding an alarm and/or flashing lights. This allows users to take proactive measures to adjust the pour rate, preventing potential formwork blowouts and ensuring safety. After the concrete pour is complete, the nut, washer, and form pressure concrete monitor unit can be easily removed from the form tie. The data collected during the pour can be stored for post-pour analysis, contributing to quality control and documentation purposes.

Once finished, the form pressure concrete monitor device can be safely stored back in its carry case for future use. This innovative system combines lightweight load cells designed for remote pressure monitoring with a form tie-based approach, offering a unique and efficient solution for concrete pour monitoring. It enhances safety, provides real-time insights, and empowers users to make informed decisions during construction projects.

Various embodiments of form pressure concrete monitor are configured to transmit data between two devices are described below and illustrated in the associated drawings. Unless otherwise specified, the several embodiments of the form pressure concrete monitor and/or their various components may contain at least one of the structure, components, functionality, and/or variations described, illustrated, and/or incorporated herein. Furthermore, the structures, components, functionalities, and/or variations described, illustrated, and/or incorporated herein in connection with the present disclosure may be included in other similar data transmission systems. The following description of various embodiments is merely illustrative in nature and is in no way intended to limit the disclosure, its application, or uses. Additionally, the advantages provided by the embodiments, as described below, are illustrative in nature and not all embodiments provide the same advantages or the same degree of advantages.

Aspects of form pressure concrete monitor may be embodied as a computer method, computer system, or computer program product. Accordingly, aspects of the form pressure concrete monitor may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the form pressure concrete monitor may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, IR, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, a solid-state drive, and/or any suitable combination of these and/or the like. In the context of this disclosure, a computer-readable storage medium may include any suitable tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including electro-magnetic, optical, audible, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including wireless, wireline, optical fiber cable, RF, and/or the like, and/or any suitable combination of these.

Computer program code for carrying out operations for aspects of the form pressure concrete monitor may be written in one or any combination of programming languages, including an object-oriented programming language such as Python, Java, Smalltalk, C++, C Sharp, Swift, and/or the like, and conventional procedural programming languages, such as the C programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the form pressure concrete monitor are described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions also can be stored in a computer-readable medium that can direct a computer, other programmable data processing apparatus, and/or other device to function in a particular manner, such that the instructions stored in the computer-readable medium produce an article of manufacture including instructions which implement the function/act specified in the flowchart and/or block diagram block or blocks.

The computer program instructions also can be loaded onto a computer, other programmable data processing apparatus, and/or other device to cause a series of operational steps to be performed on the device to produce a computer-implemented process such that the instructions which execute on the computer or other programmable apparatus provide processes for implementing the functions/acts specified in the flowchart and/or block diagram block or blocks.

Any flowchart and/or block diagram in the drawings is intended to illustrate the architecture, functionality, and/or operation of possible implementations of systems, methods, and computer program products according to aspects of the form pressure concrete monitor. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

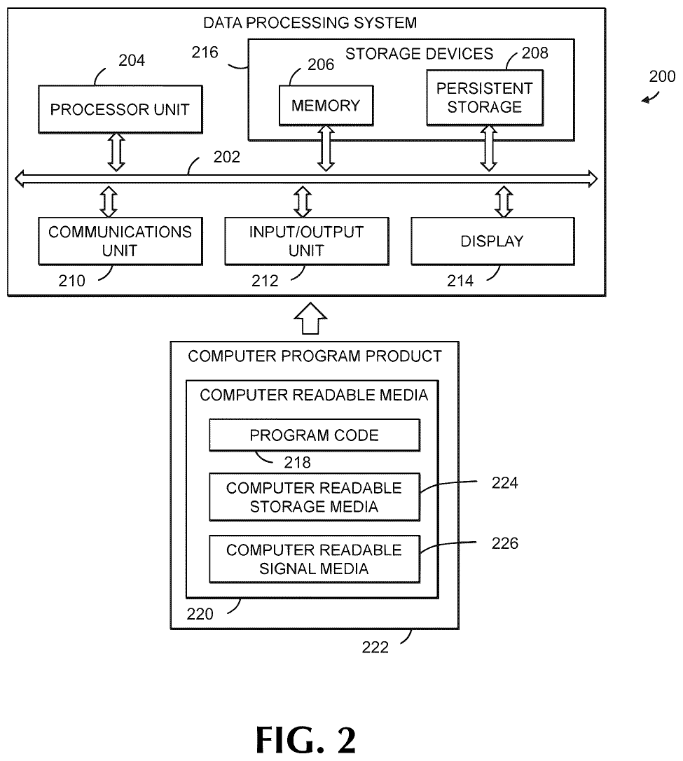

FIG. 2 shows, in accordance with aspects of the present disclosure, an example describing a data processing system 200. In this example, data processing system 200 is an illustrative data processing system suitable for implementing aspects of form pressure concrete monitor methods and systems. More specifically, in some examples, devices that are embodiments of data processing systems, e.g., smartphones, tablets, personal computers may be used by one or more users such as retailers, customers, advertisers, consumers, patients, healthcare providers, etc. Further, devices that are embodiments of data processing systems, e.g., smartphones, tablets, personal computers, may be used as one or more server(s) in encoding, decoding, and communicating signals with one or more mobile communication devices.

In this illustrative example, data processing system 200 includes communications framework 202. Communications framework 202 provides communications between processor unit 204, memory 206, persistent storage 208, communications unit 210, input/output (I/O) unit 212, and display 214. Memory 206, persistent storage 208, communications unit 210, input/output (I/O) unit 212, and display 214 are examples of resources accessible by processor unit 204 via communications framework 202.

Processor unit 204 serves to run instructions that may be loaded into memory 206. Processor unit 204 may be a number of processors, a multi-processor core, or some other type of processor, depending on the particular implementation. Further, processor unit 204 may be implemented using a number of heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and other suitable information either on a temporary basis or a permanent basis.

Storage devices 216 also may be referred to as computer-readable storage devices in these examples. Memory 206, in these examples, may be, for example, a random-access memory or any other suitable volatile or non-volatile storage device. Persistent storage 208 may take various forms, depending on the particular implementation.

For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output (I/O) unit 212 allows for input and output of data with other devices that may be connected to data processing system 200. For example, input/output (I/O) unit 212 may provide a connection for user input through a keyboard, a mouse, and/or some other suitable input device. Further, input/output (I/O) unit 212 may send output to a printer. Display 214 provides a mechanism to display information to a user.

Instructions for the operating system, applications, and/or programs may be located in storage devices 216, which are in communication with processor unit 204 through communications framework 202. In these illustrative examples, the instructions are in a functional form on persistent storage 208. These instructions may be loaded into memory 206 for execution by processor unit 204. The processes of the different embodiments may be performed by processor unit 204 using computer-implemented instructions, which may be located in a memory, such as memory 206.

These instructions are referred to as program instructions, program code, computer usable program code, or computer-readable program code that may be read and executed by a processor in processor unit 204. The program code in the different embodiments may be embodied on different physical or computer-readable storage media, such as memory 206 or persistent storage 208.

Program code 218 is located in a functional form on computer-readable media 220 that is selectively removable and may be loaded onto or transferred to data processing system 200 for execution by processor unit 204. Program code 218 and computer-readable media 220 form computer program product 222 in these examples. In one example, computer-readable media 220 may be computer-readable storage media 224 or computer-readable signal media 226.

Computer-readable storage media 224 may include, for example, an optical or magnetic disk that is inserted or placed into a drive or other device that is part of persistent storage 208 for transfer onto a storage device, such as a hard drive, which is part of persistent storage 208. Computer-readable storage media 224 also may take the form of a persistent storage, such as a hard drive, a thumb drive, or a flash memory, which is connected to data processing system 200. In some instances, computer-readable storage media 224 may not be removable from data processing system 200.

In these examples, computer-readable storage media 224 is a physical or tangible storage device used to store program code 218 rather than a medium that propagates or transmits program code 218. Computer-readable storage media 224 is also referred to as a computer-readable tangible storage device or a computer-readable physical storage device. In other words, computer-readable storage media 224 is non-transitory.

Alternatively, program code 218 may be transferred to data processing system 200 using computer-readable signal media 226. Computer-readable signal media 226 may be, for example, a propagated data signal containing program code 218. For example, computer-readable signal media 226 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer-readable signal media 226 for use within data processing system 200. For instance, program code stored in a computer-readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to and/or in place of those illustrated for data processing system 200. Other components shown in FIG. 2 can be varied from the illustrative examples shown. The different embodiments may be implemented using any hardware device or system capable of running program code. As one example, data processing system 200 may include organic components integrated with inorganic components and/or may be comprised entirely of organic components excluding a human being. For example, a storage device may be comprised of an organic semiconductor.

In another illustrative example, processor unit 204 may take the form of a hardware unit that has circuits that are manufactured or configured for a particular use. This type of hardware may perform operations without needing program code to be loaded into a memory from a storage device to be configured to perform the operations.

For example, when processor unit 204 takes the form of a hardware unit, processor unit 204 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a field programmable logic array, a field programmable gate array, and other suitable hardware devices. With this type of implementation, program code 218 may be omitted, because the processes for the different embodiments are implemented in a hardware unit.

In still another illustrative example, processor unit 204 may be implemented using a combination of processors found in computers and hardware units. Processor unit 204 may have a number of hardware units and a number of processors that are configured to run program code 218. With this depicted example, some of the processes may be implemented in the number of hardware units, while other processes may be implemented in the number of processors.

In another example, a bus system may be used to implement communications framework 202 and may be comprised of one or more buses, such as a system bus or an input/output (I/O) bus. Of course, the bus system may be implemented using any suitable type of architecture that provides for a transfer of data between different components or devices attached to the bus system.

Additionally, communications unit 210 may include a number of devices that transmit data, receive data, or both transmit and receive data. Communications unit 210 may be, for example, a modem or a network adapter, two network adapters, or some combination thereof. Further, a memory may be, for example, memory 206, or a cache, such as that found in an interface and memory controller hub that may be present in communications framework 202.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the drawings. For example, the functions of two blocks shown in succession may be executed substantially concurrently, or the functions of the blocks may sometimes be executed in the reverse order, depending upon the functionality involved.

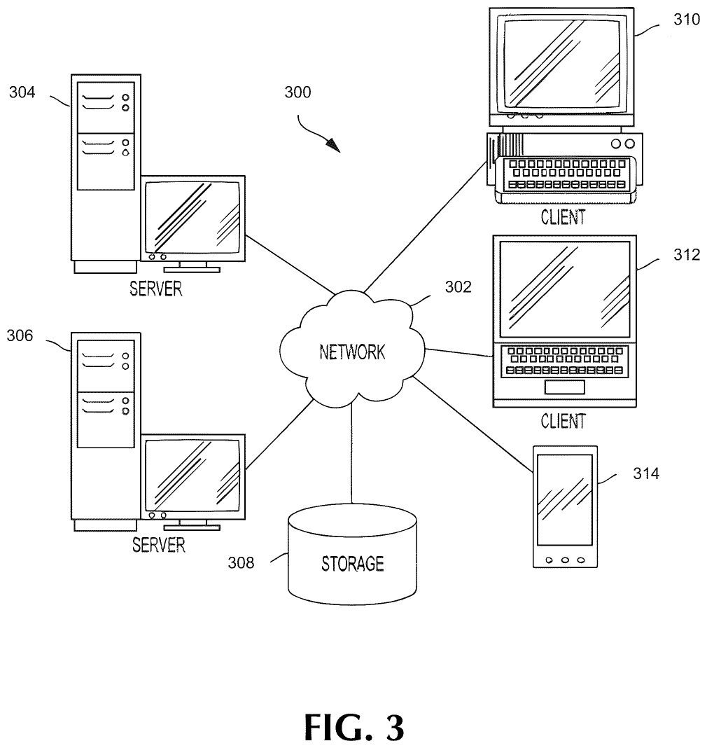

FIG. 3 shows an example describing a general network data processing system 300, interchangeably termed a network, a computer network, a network system, or a distributed network, aspects of which may be included in one or more illustrative embodiments of form pressure concrete monitor methods and systems. For example, one or more mobile computing devices or data processing devices may communicate with one another or with one or more servers(s) through the network. It should be appreciated that FIG. 3 is provided as an illustration of one implementation and is not intended to imply any limitation with regard to environments in which different embodiments may be implemented. Many modifications to the depicted environment may be made.

Network data processing system 300 is a network of computers, each of which is an example of data processing system 200, and other components. Network data processing system 300 may include network 302, which is a medium configured to provide communications links between various devices and computers connected together within network data processing system 300. Network 302 may include connections such as wired or wireless communication links, fiber optic cables, and/or any other suitable medium for transmitting and/or communicating data between network devices, or any combination thereof.

In the depicted example, a first network device 304 and a second network device 306 connect to network 302, as does an electronic storage device 308. Network devices 304 and 306 are each examples of data processing system 200, described above. In the depicted example, devices 304 and 306 are shown as server computers. However, network devices may include, without limitation, one or more personal computers, mobile computing devices such as personal digital assistants (PDAs), tablets, and smart phones, handheld gaming devices, wearable devices, tablet computers, routers, switches, voice gates, servers, electronic storage devices, imaging devices, and/or other networked-enabled tools that may perform a mechanical or other function. These network devices may be interconnected through wired, wireless, optical, and other appropriate communication links.

In addition, client electronic devices, such as a client computer 310, a client laptop or tablet 312, and/or a client smart device 314, may connect to network 302. Each of these devices is an example of data processing system 200, described above regarding FIG. 7. Client electronic devices 310, 312, and 314 may include, for example, one or more personal computers, network computers, and/or mobile computing devices such as personal digital assistants (PDAs), smart phones, handheld gaming devices, wearable devices, and/or tablet computers, and the like. In the depicted example, server 304 provides information, such as boot files, operating system images, and applications to one or more of client electronic devices 310, 312, and 314. Client electronic devices 310, 312, and 314 may be referred to as “clients” with respect to a server such as server computer 304. Network data processing system 300 may include more or fewer servers and clients or no servers or clients, as well as other devices not shown.

Client smart device 314 may include any suitable portable electronic device capable of wireless communications and execution of software, such as a smartphone or a tablet. Generally speaking, the term “smartphone” may describe any suitable portable electronic device having more advanced computing ability and network connectivity than a typical mobile phone. In addition to making phone calls (e.g., over a cellular network), smartphones may be capable of sending and receiving emails, texts, and multimedia messages, accessing the Internet, and/or functioning as a web browser. Smart devices (e.g., smartphones) may also include features of other known electronic devices, such as a media player, personal digital assistant, digital camera, video camera, and/or global positioning system. Smart devices (e.g., smartphones) may be capable of connecting with other smart devices, computers, or electronic devices wirelessly, such as through near field communications (NFC), BLUETOOTH®, Wi-Fi, or mobile broadband networks. Wireless connectivity may be established among smart devices, smartphones, computers, and other devices to form a mobile network where information can be exchanged.

Program code located in system 300 may be stored in or on a computer recordable storage medium, such as persistent storage 308 in FIG. 3, and may be downloaded to a data processing system or other device for use. For example, program code may be stored on a computer recordable storage medium on server computer 304 and downloaded for use to client 310 over network 302 for use on client 310.

Network data processing system 300 may be implemented as one or more of a number of different types of networks. For example, system 300 may include an intranet, a local area network (LAN), a wide area network (WAN), or a personal area network (PAN). In some examples, network data processing system 300 includes the Internet, with network 302 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. FIG. 3 is intended as an example, and not as an architectural limitation for any illustrative embodiments.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A load cell assembly, comprising:
a) a housing with a central cutout, wherein said cutout is configured to accommodate attachment to a form tie of a formwork;
b) a plurality of sensors integrated into said housing, including:
i) a first sensor and a second sensor, each positioned adjacent to, but on opposite sides of, said cutout defining a first axis, wherein said first and second sensors are configured to detect changes in pressure exerted on said formwork; and
ii) a third sensor and a fourth sensor, each positioned further from, but on opposite sides of, said cutout defining a second axis, wherein said third sensor is configured to detect tensile forces exerted on said formwork, and said fourth sensor is configured to detect compressive forces exerted on said formwork;
wherein said first and second sensors are configured to detect static and dynamic pressure changes on said formwork, and said third and fourth sensors are configured to detect corresponding tensile and compressive forces;
wherein said first, second, third, and fourth sensors are operatively connected to a processor.

2. The load cell assembly of claim 1, wherein said housing is constructed from hardened steel or a corrosion-resistant metal alloy.

3. The load cell assembly of claim 1, wherein said first, second, third, and fourth sensors are configured to operate within a temperature-compensated range.

4. The load cell assembly of claim 1, wherein said first, second, third, and fourth sensors are configured as a full-bridge strain gauge circuit, wherein said first axis is perpendicular to said second axis, and wherein said circuit is operatively connected to said processor.

5. A method for monitoring concrete formwork pressure, comprising:
a) detecting forces exerted on a formwork using a load cell assembly, said assembly comprising one or more pressure sensors configured to detect changes in pressure on said formwork;
b) detecting vibrations using an accelerometer;
c) receiving, by a processor, one or more outputs from said load cell assembly and vibration data from said accelerometer, wherein said processor is operatively connected to said load cell assembly and to said accelerometer;
d) analyzing, by said processor, said outputs to determine exerted forces on said formwork and analyzing said vibration data to identify one or more vibration events affecting pressure on said formwork;
e) adjusting, by said processor, said determined forces exerted on said formwork based on said identified vibration events;
f) comparing, by said processor, said adjusted forces to a predefined threshold; and
g) generating, by said processor, one or more signals indicating one or more occurrences of said vibration events and whether said adjusted forces are within a specified range of said predefined threshold.

6. The method of claim 5, further comprising transmitting, by said processor, said analyzed outputs, said adjusted forces, said identified vibration events, and said signals to a device.

7. A concrete form pressure monitoring system, comprising:
a) a sensor network including two or more load cell assemblies, wherein each load cell assembly is configured to detect one or more parameters associated with forces exerted on a respective region of a formwork, said parameters including one or more outputs from a pressure sensor configured to detect changes in pressure exerted on said formwork in said respective region; and
b) a processor operatively connected to said sensor network, said processor configured to:
i) receive said parameters from each said load cell assembly;
ii) determine from said received parameters said forces exerted on said formwork at each of said respective region of each said load cell assembly;
iii) compare said determined forces to one or more predefined thresholds, wherein each said respective region of said formwork has one or more said thresholds specific to said respective region; and
iv) generate one or more signals based on said determined forces at said respective region of said load cell assembly and said predefined thresholds.

8. The system of claim 7, wherein each said load cell assembly comprises at least two tension sensors and at least two compression sensors; and

[symbol]

9. The system of claim 7, wherein said sensor network further comprises one or more environmental sensors configured to detect ambient conditions, including temperature and humidity, and wherein said processor is further configured to adjust said determined forces based on said environmental conditions.

10. The system of claim 7, wherein said signals include an alert signal when said determined forces at any of said respective regions are within specified margins of said thresholds.

11. The system of claim 7, wherein said processor is further configured to identify pressure imbalances across said formwork, wherein said processor compares forces between adjacent regions and generates an alert when an imbalance is detected.

12. The system of claim 7, wherein said processor is configured to aggregate data from all said load cell assemblies and provide a map of pressure exerted across said formwork to a user interface.

13. A method for monitoring concrete form pressure, comprising:
a) detecting one or more forces exerted on two or more regions of a formwork using a sensor network, said sensor network including two or more load cell assemblies, wherein each said load cell assembly is configured to obtain one or more parameters associated with said forces exerted on a respective region of said formwork, said parameters including one or more outputs from a pressure sensor configured to detect changes in pressure exerted on said formwork in said respective region; and
b) receiving said parameters from each said load cell assembly by a processor, wherein said processor is operatively connected to said sensor network;
c) determining, by said processor, from said received parameters exerted forces on said formwork at each of said regions of said formwork;
d) comparing, by said processor, said determined exerted forces to one or more predefined thresholds, wherein each of said regions of said formwork has one or more thresholds specific to each said respective region; and
e) generating, by said processor, one or more signals based on said determined exerted forces at each of said regions of said formwork and said predefined thresholds.

14. The method of claim 13, wherein detecting said exerted forces includes detecting compression forces and tension forces exerted on said formwork using each said load cell assembly, wherein each load cell assembly includes at least two tension sensors and at least two compression sensors a tension sensor to detected said exerted forces on said formwork in respective said region.

15. The method of claim 13, further comprising detecting environmental conditions, including temperature and humidity, at each of said regions of the formwork, wherein said processor is further configured to determine concrete set and curing times.

16. The method of claim 13, wherein said one or more signals include an alert signal when said determined exerted forces at any of said regions are within specified ranges of said thresholds specific to said respective region.

17. The method of claim 13, further comprising aggregating said received parameters from said load cell assemblies, wherein said processor generates a comprehensive analysis of said forces exerted across said regions of said formwork.

18. The method of claim 13, further comprising storing said exerted forces at each of said respective region, wherein said processor utilizes said stored data to forecast future force patterns.

19. The method of claim 13, wherein said processor is further configured to identify pressure imbalances across adjacent regions of said formwork, wherein said processor compares said forces between regions and generates an alert signal if an imbalance is detected.

20. The method of claim 13, further comprising detecting vibration forces in said formwork during the concrete pouring process, and wherein said processor adjusts said determined forces and said signals based on said dynamic forces.
